(19) United States
(12) Patent Application Publication
(10) Pub. No.: US 2025/0260650 A1
(43) Pub. Date: Aug. 14, 2025

(54) INTERCONNECT DEVICE LOAD BALANCING

(71) Applicant: MELLANOX TECHNOLOGIES, LTD., Yokneam (IL)

(72) Inventors: Niv Aibester, Herzliya (IL); Eyal Srebro, Kfar Yehoshua (IL); Amit Kazimirsky, Givat-Shmuel (IL)

(21) Appl. No.: 18/440,777

(22) Filed: Feb. 13, 2024

(51) Int. Cl. H04L 47/25

(52) U.S. Cl. CPC H04L 47/25

(57) ABSTRACT

An interconnect device is provided. In one example, an interconnect device includes ports and circuits to determine a rate of change in a number of entries in a queue exceeds a first threshold or falls below a second threshold. In response to the rate of change in the number of entries in the queue exceeding the first threshold or falling below the second threshold, a rate at which packets to be transmitted from the interconnect device are processed for egress may be reduced to avoid an excessive drop or rise in power consumption of the interconnect device.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. Such interconnected entities form a network that enables data communication and resource sharing among the nodes. While a particular switch may be capable of handling large amounts of data, often, switches do not operate at full capacity.

Switches operating at full capacity are power-intensive devices. As packet-processing complexity increases and overall bandwidth increases, the power requirements of switches increase.

### BRIEF SUMMARY

An important power efficiency attribute of a switch is lower-power consumption when possible, such as when a switch idles. This aspect stresses to the physical-limit transient events the switch needs to handle. The overall power (in terms of current) the switch pulls and requires from idle-power state to max-power state, referred to as dI/dt, reflects the maximum change (delta) of current required when driving the switch from idle to full switching condition.

This attribute is derived from power at maximum conditions versus power at idle state. When a switch goes from idle to max power, an extremely high dI/dT is achieved. As switches are improved to allow more bandwidth, increasing the maximum power conditions, and to improve power consumption, decreasing the power consumption at idle state, the dI/dT becomes more and more extreme. However, conventional power supply systems are incapable of efficiently providing power in response to the needs of a switch during extreme dI/dT events.

In accordance with one or more embodiments described herein, a computing system, such as an interconnect device, may enable a diverse range of systems, such as switches, servers, personal computers, and other computing devices, to communicate across a network. Such a computing system, which may be referred to herein as an interconnect device or switch, may implement one or more load balancing or throttling mechanisms. Implementing a load balancing mechanism may include monitoring ingress bandwidth and/or contents of a queueing or scheduling system to detect a sharp increase or sharp decrease in the rate of packets being transmitted through an interconnect device. In response to such a sharp increase or decrease in the bandwidth of data transmitted through the interconnect device, the queueing system may delay the scheduling of packets to be sent from the interconnect device. In some implementations, the load balancing or throttling mechanisms described herein may be applied for each voltage rail used by a device. For example, a device such as a switch may utilize multiple voltage rails. Each voltage rail may service a different logic area, such as for a buffer circuit, encryption circuits, queueing circuits, etc. The systems and methods described herein may be used to address a dl/dT event occurring on a particular rail.

The present disclosure describes a system and method for enabling an interconnect device, such as a switch, or other computing system to efficiently respond to sharp increases and decreases in power consumption. Implementations described herein involve the throttling of bandwidth based on sharp increases and/or decreases in traffic.

In some examples, a rate controller of a switch may be enabled to respond to a detection of an increase or decrease of ingress packets exceeding a maximum rate. Following the detection of the increase or decrease of ingress packets exceeding the maximum rate, a rate of change of packets reaching a queueing system may be monitored for a period of time. If the rate of change of packets reaching the queueing system exceeds a maximum rate during the period of time, the rate controller may delay the scheduling of packets by the queueing system. Delaying the packet scheduling may take place on a time unit basis. For example, when a large amount of pending queues is detected in a small time-window, the amount of delaying may vary on a time-basis, such as a clock cycle. The scheduling may begin at a minimum rate for one time unit, followed by a slight increase in scheduling for a next time unit, and the process may continue until the scheduling has returned to the maximum rate. By delaying the scheduling of packets by the queuing system, the switch may avoid increasing and/or decreasing its power consumption too quickly.

Embodiments of the present disclosure aim to improve power efficiency and other issues by implementing a load balancing approach. The load balancing approach depicted and described herein may be applied to a switch, a router, or any other suitable type of networking device known or yet to be developed. In an illustrative example, a system is disclosed that includes one or more circuits to determine a rate of change in a number of entries in a queue exceeds a first threshold; and based on determining the rate of change in the number of entries in the queue exceeds the first threshold, dynamically adjust a rate at which packets to be transmitted from the switch are processed for egress. The rate of change in the number of entries in the queue may be characterized by an amount of queues pending transmission within a particular time window.

In another example, a method is disclosed that includes determining a rate of change in a number of entries in a queue exceeds a first threshold; and based on determining the rate of change in the number of entries in the queue exceeds the first threshold, dynamically adjusting a rate at which packets to be transmitted from a switch are processed for egress. The rate of change in the number of entries in the queue may be determined by measuring a change in an amount of queues or ports that asked to be serviced by a scheduler within a specific time window.

In yet another example, a switch is disclosed that includes one or more circuits to determine a negative rate of change in a number of packets ingressing the switch exceeds a threshold; and in response to determining the negative rate of change in the number of packets ingressing the switch exceeds the threshold, dynamically adjust a rate at which the packets to be transmitted from the switch are processed for egress.

Any of the above example aspects include wherein the one or more circuits are further to: after dynamically adjusting the rate at which the packets to be transmitted from the switch are processed for egress, determine the rate of change is below the first threshold; and in response to determining the rate of change is below the first threshold, cease dynamically adjusting the rate at which the packets to be transmitted from the switch are processed for egress.

Any of the above example aspects include wherein dynamically adjusting the rate at which the packets to be transmitted from the switch are processed for egress comprises increasing the rate from a first rate to a second rate over time.

Any of the above example aspects include wherein the second rate is a maximum rate.

Any of the above example aspects include wherein dynamically adjusting the rate at which the packets to be transmitted from the switch are processed for egress controls an increase in an amount of power consumed by the switch.

Any of the above example aspects include wherein the increase in the amount of power consumed by the switch is delayed.

Any of the above example aspects include wherein dynamically adjusting the rate at which the packets to be transmitted from the switch are processed for egress comprises delaying a scheduling of the packets to be transmitted from the switch to one or more egress queues.

Any of the above example aspects include wherein dynamically adjusting the rate at which the packets to be transmitted from the switch are processed for egress affects a first one or more flows of a plurality of flows traversing the switch and a second one or more flows of the plurality of flows continue unaffected by the adjusting of the rate at which the packets to be transmitted from the switch are processed for egress.

Any of the above example aspects include wherein the one or more circuits are further to determine a rate of change in a number of packets ingressing the switch, and dynamically adjusting the rate at which the packets to be transmitted from the switch are processed for egress is further in response to determining the rate of change in a number of packets ingressing the switch exceeds a second threshold.

Any of the above example aspects include wherein each entry represents a respective packet of a plurality of packets to be transmitted from the switch.

Any of the above example aspects include wherein dynamically adjusting the rate at which the packets to be transmitted from the switch are processed for egress controls a reduction in an amount of power consumed by the switch.

Any of the above example aspects include wherein dynamically adjusting the rate at which the packets to be transmitted from the switch are processed for egress comprises delaying a scheduling of the packets to be transmitted from the switch to one or more egress queues.

Any of the above example aspects include wherein the one or more circuits are further to: after dynamically adjusting the rate at which the packets to be transmitted from the switch are processed for egress, determine the negative rate of change is below the threshold; and in response to determining the rate of change is below the threshold, cease dynamically adjusting the rate at which the packets to be transmitted from the switch are processed for egress.

Any of the above example aspects include wherein dynamically adjusting the rate at which the packets to be transmitted from the switch are processed for egress comprises decreasing the rate from a first rate to a second rate over time.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a network in accordance with at least some embodiments of the present disclosure;

FIG. 2 is a block diagram depicting an illustrative configuration of an interconnect device in accordance with at least some embodiments of the present disclosure;

FIG. 3 is a block diagram depicting an illustrative configuration of routing circuitry of an interconnect device in accordance with at least some embodiments of the present disclosure;

FIG. 4 is a graph depicting power consumption of an interconnect device over time; and

FIG. 5 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Since the purpose of an interconnect device may be on-demand packet-forwarding for incoming packets from clients and processing devices, an interconnect device may have periods during which few or no packets are traversing the interconnect device. During such low-traffic periods, the interconnect device may operate at a reduced power level. However, at any moment the interconnect device may receive a burst of traffic requiring the interconnect device to operate at increased or full power. The time required for such an interconnect device to go from idle to fully operational may be referred to as Delta T. In an ideal interconnect device, Delta T is a relatively short amount of time. During Delta T, the entire logic of the interconnect device is loaded, ramping up very rapidly, pulling current from a power supply or voltage regulator (VR). The effort required to enable all the logic within the switch may result in the VR or power supply not being able to supply the required current in sufficient time due to resistance and/or impedance. While the systems and methods described herein relate to an interconnect device or a switch, it should be appreciated the systems and methods may be used for any device capable of sending and receiving data. For example, a device including a GPU or Cpu may include dedicated logic for networking. Such networking logic may utilize the dl/dT mitigation systems described herein, as the networking logic may be required to react as fast as possible to any transmission request or to any received data.

When an interconnect device increases its power consumption from near zero to a maximum at a step of Delta A, a drop in power (which may be referred to as a droop or undershoot) occurs near the max (V_{Droop} or V_{Undershoot}). This droop may occur for a short time, when the VR works to provide the maximum amount of power to supply the voltage.

In order to address the droop/undeshoot effect with conventional approaches, a constant increase to the voltage may be applied such that when a droop occurs, the minimum-voltage required for the device to operate is maintained, even under dI/dT conditions.

A device such as a switch must consume some power even at idle. Such devices may be associated with a minimum constant voltage, or Vₘᵢₙ. If a V_{Droop} occurs such that that the voltage of the device drops below the Vₘᵢₙ, the device may stop operating. For this reason, conventional devices may operate at a minimum voltage of Vₘᵢₙ+V_{droop} to ensure that the voltage of the device never drops below Vₘᵢₙ event if a droop occurs due to a dI/dT event or other cause. Such an increase in voltage results in an overall increase in power consumption of the device. As a result, the dl/dT affects the overall power demand for a switch or other device. Through the systems and methods described herein, the effects of a dI/dT event can be mitigated, reducing the average power consumption of a device such as a switch.

A similar issue occurs when an interconnect decreases its power consumption from a maximum to zero or near zero. Such a scenario may occur as a result of an interconnect device operating at full capacity suddenly receiving little to no traffic. The power consumption of the ingress-related circuits of the interconnect device will drop from a maximum to a minimum amount followed by the power consumption of the egress-related circuits. If the drop of the overall power consumption of the interconnect device occurs too drastically and too quickly, the internal power supply of the interconnect may inefficiently experience an overshoot near the minimum (V_{Overshoot}).

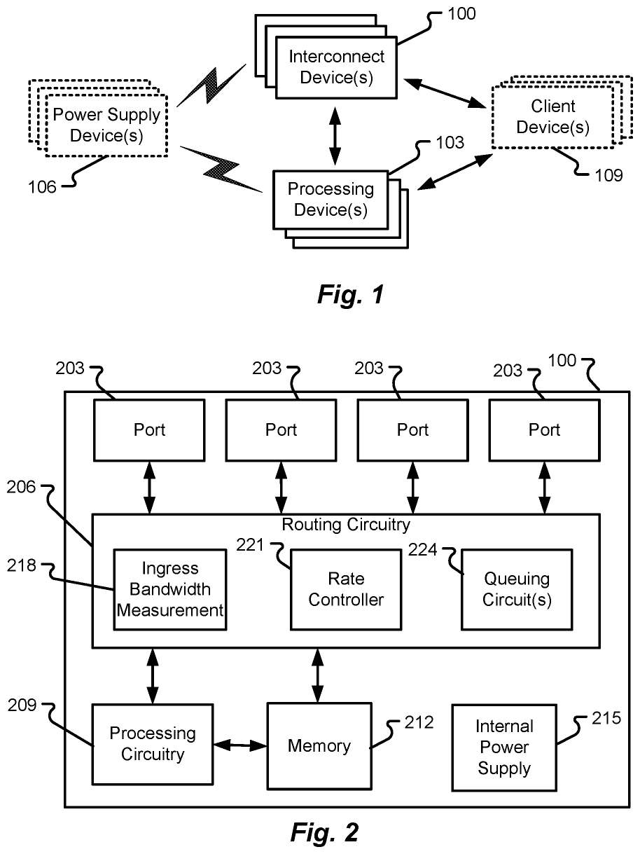

As described herein, systems and methods of load-balancing may be used to avoid the drop in power resulting from the sharp increase or decrease in power consumption. Referring now to FIGS. 1-5, various systems and methods for implementing a load-balancing in an interconnect device will be described. The concepts of load-balancing depicted and described herein can be applied to any suitable type of computing system capable of receiving and/or transmitting data, whether the computing system includes one port or a plurality of ports. Such a computing system may include a switch, but it should be appreciated any type of computing system may be used. The ability of interconnect devices, such as switches, to traverse data is constantly increasing, forwarding packet-processing is becoming more complex as a result power-requirements, and power-density of interconnect devices is increasing.

As illustrated in FIG. 1, a computing environment as described herein may be a network of processing devices 103 interconnected by interconnect devices 100. One or more interconnect devices 100 may be in communication with one or more processing devices 103. The network of processing devices 103 and interconnect devices 100 may be in communication with one or more client devices 109. The processing devices 103 and interconnect devices 100 may be powered by one or more power supply devices 106. Such a network of processing devices 103 and interconnect devices 100 may be useful in various settings, from data centers and cloud computing infrastructures to artificial intelligence systems.

Processing devices 103 may be computing units, such as personal computers, servers, or other computing devices, and may be responsible for executing applications and performing data processing tasks. Processing devices 103 as described herein can range from servers in a data center to desktop computers in a network, or to devices such as internet of things (IoT) sensors and smart devices.

Each processing device 103 may include one or more processing circuits, such as Graphics Processing Units (GPUs), central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, processing devices 103 may also or alternatively include hardware such as GPUs for handling intensive tasks for machine learning, artificial intelligence (AI) workloads, or other complex processes.

For example, processing devices 103 may operate as a high-performance computing (HPC) cluster. A cluster of processing devices 103 may comprise numerous interconnected servers, each equipped with powerful CPUs and/or GPUs. The processing devices 103 may provide computational horsepower for, as an example, training large-scale AI models or running complex scientific simulations. For AI and machine learning tasks, the processing devices 103 may comprise one or more GPUs or other processing circuitry which may be capable of handling parallel processing requirements of neural networks and other applications.

Interconnect devices 100, as described in greater detail herein, may enable communication between processing devices 103 and/or client devices 109. An interconnect device 100 may be, for example, a switch, a network interface controller (NIC), or other device capable of receiving and sending data, and may act as a central node in the network. Interconnect devices 100 may be wired in a topology including spine switches and top-of-rack (TOR) switches for example. Interconnect devices 100 may be capable of receiving, processing, and forwarding data, e.g., packets, to appropriate destinations within the network, such as processing devices 103 and/or client devices 109. In some implementations, an interconnect device 100 may be included in a switch box, a platform, or a case which may contain one or more interconnect devices 100 as well as one or more power supply devices 106.

In some implementations, each processing device 103 may be connected to one or more ports of one or more interconnect devices 100 via network cables or wirelessly. Processes, such as applications, executed by processing devices 103 may involve transmitting data to nodes of the network, such as to other processing devices 103 and/or to client devices 109. Data may flow through the network of processing devices 103 and interconnect devices 100 using one or more protocols such as transmission control protocol (TCP), user datagram protocol (UDP), or Internet protocol (IP), for example. Each interconnect device 100 may, upon receiving data from a processing device 103 or another interconnect device 100, examine the data to identify a destination for the data and route the data through the network.

Each interconnect device 100 may receive power from one or more power supply devices 106. A power supply device 106 may comprise a power regulator or other power supply circuitry, referred to herein as an internal power supply 215 as described below in relation to FIG. 2. In some implementations, a power supply device 106 may supply power to an internal power supply 215 of an interconnect device 100 which may sustain power as required for a particular interconnect device 100. As described below, an internal power supply 215 of an interconnect device may include a voltage regulator (VR). For example, a VR may sustain 600 watts, although applications executed by an interconnect device 100 may on average consume much less power.

When an interconnect device 100 is not actively being used to transmit data, the interconnect device 100 may enter a standby or low-power mode. During such times, the interconnect device 100, while not consuming more than an average amount of power, may remain capable of receiving, processing, and forwarding a packet when needed. As such, the power supply device 106 may supply interconnect devices 100 sufficient power to meet demands of processing devices 103. The power supply device(s) 106 may be capable of supporting both the interconnect devices 100 and the processing devices 103 with sufficient power to accomplish necessary tasks at the proper times.

Client devices 109 as described herein may be computing devices which, for example, engage in Al-related, research-related, and other processor-intensive tasks, and utilize processing devices 103 to handle the computational loads and data throughput required by such intensive applications. Client devices 109 may include, for example, workstations and personal computers used by researchers, data scientists, and professionals for developing, testing, and running AI models and research simulations. Client devices 109 may include one or more CPUs and/or GPUs but may require additional computational power for complex tasks.

By interacting with processing devices 103, client devices 109 may be enabled to perform functions such as training machine learning models, performing data processing, running simulations, analyzing large datasets, and performing complex data processing tasks, such as data mining, pattern recognition, and predictive modeling, for examples.

An interconnect device 100 as described herein may in some implementations be as illustrated in FIG. 2. Such an interconnect device 100 may include a plurality of ports 203, routing circuitry 206, processing circuitry 209, memory 212, and an internal power supply 215.

The internal power supply 215 may in some implementations receive power from an external power supply device 106. An internal power supply 215 may comprise a power regulator or other power supply circuitry. In some implementations, the internal power supply 215 may comprise a voltage regulator (VR) which may be capable of sustaining power as required for a particular interconnect device 100. For example, a VR may sustain 600 watts, although applications executed by an interconnect device 100 may on average consume much less power.

An internal power supply 215 of an interconnect device 100 may include any one or more of a linear VR, switching VR, series VR, shunt VR, buck regulator, boost regulator, buck-boost regulator, Cuk converter, flyback converter, forward converter, push-pull regulator, and/or a half- and/or full-bridge regulator. In some implementations, an internal power supply 215 of an interconnect device 100 may include any one or more of an AC-to-DC power supply, a DC-to-DC converter, a power-over-Ethernet (POE) supply, a battery, and/or other components capable of supplying power for use by the interconnect device 100.

The ports 203 of an interconnect device 100 may be capable of facilitating the transmission of data packets, or non-packetized data, into, out of, and through the interconnect device 100. Such ports 203 may serve as interface points where network cables may be connected, connecting the interconnect device 100 with other interconnect devices 100, processing devices 103, and/or client devices 109.

Each port 203 may be capable of receiving incoming data packets from other devices and/or transmitting outgoing data packets to other devices. In some implementations, ports 203 may be configured to operate as either dedicated ingress or egress ports 203 or may be enabled to operate in a dual functionality capable of performing ingress and egress functions. For example, an egress port 203 may be used exclusively for sending data from the interconnect device and an ingress port 203 may be used solely for receiving incoming data into the switch.

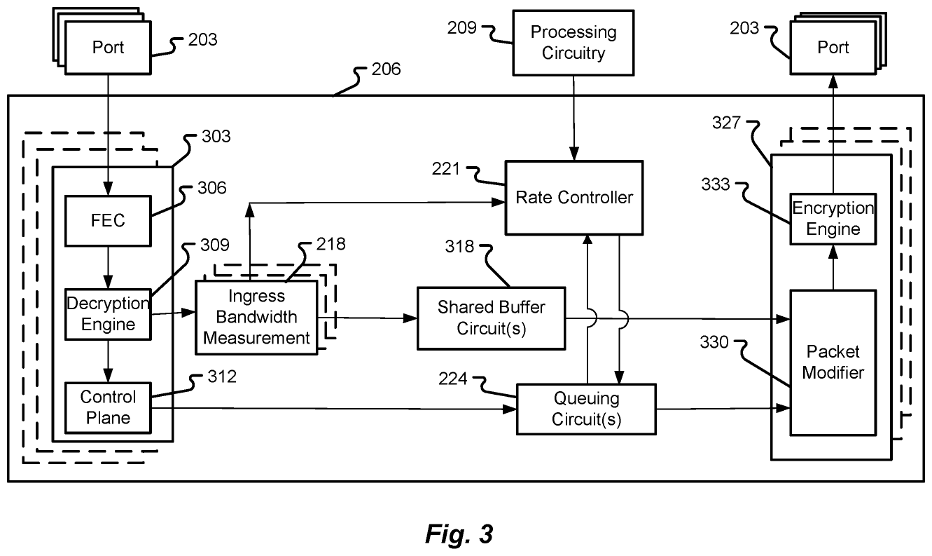

Routing circuitry 206 of an interconnect device 100, as described in greater detail below and in relation to FIG. 3, may be capable of handling a received packet by determining a port from which to send the packet and forwarding the packet from the determined port. Using a system or method as described in greater detail below, routing circuitry 206 may be capable of throttling the traversal of data through the interconnect device 100 in the event of a surge or sudden drop in power consumption. As a result, the routing circuitry 206 may be capable of avoiding issues relating to overshoots and/or undershoots.

Routing circuitry 206, as described in greater detail below, may include one or more ingress bandwidth measurement circuits 218. Ingress bandwidth measurement circuits 218 may be circuitry capable of detecting, or being used by another element to detect, a sharp increase or decrease in ingress traffic. In some implementations, each port 203 of an interconnect device may be associated with a designated ingress bandwidth measurement circuit 218, while in other implementations an ingress bandwidth measurement circuit 218 may be capable of determining an aggregate bandwidth for all ingress ports 203.

A sharp increase or decrease in ingress traffic may be determined by measuring a rate of change in ingress traffic over time. In some implementations, a sharp increase may be defined by the rate of change in ingress traffic over time exceeding or meeting an upper threshold and a sharp decrease may be defined by the rate of change in ingress traffic over time falling below or meeting a lower threshold.

Routing circuitry 206, as described in greater detail below, may include one or more queuing circuits 224. A queuing circuit 224 may be capable of handling the scheduling of packets traversing the interconnect device 100. The queuing circuits 224 may include one or more memory elements containing transmission queue entries. Each transmission queue entry may correspond to a packet awaiting scheduling by a queuing circuit 224. During normal operation of the interconnect device 100, the queuing circuits 224 may be configured to schedule transmission queue entries as fast as possible to avoid lag or a disruption in the flow of data. However, using a system or method as described herein, a queuing circuit 224 may be configured to delay the scheduling of transmission queue entries in particular scenarios. The delay in scheduling may in some implementations be controlled by or in response to one or more rate controller 221 as described below.

Queuing circuits 224 may also be enabled to monitor a rate of change in the number of transmission queue entries awaiting scheduling. For example, a queuing circuit 224 may be capable of determining a number of transmission queue entries to be scheduled at any given time. A queuing circuit 224 may also be capable of determining a rate of change in the number of transmission queue entries to be scheduled. If the rate of change is positive and exceeds an upper threshold, the queuing circuit 224 may be enabled to determine a dl/dT event has occurred. Similarly, if the rate of change is negative and falls below a lower threshold, the queuing circuit 224 may be enabled to determine a dI/dT event has occurred.

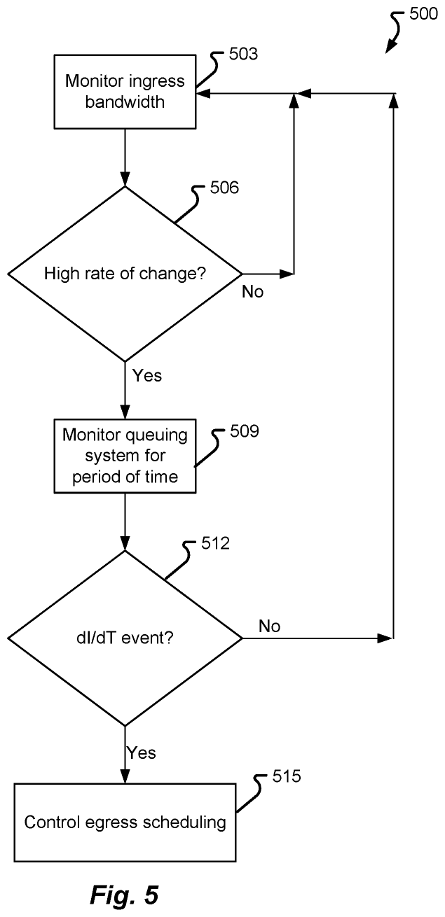

Routing circuitry 206, as described in greater detail below, may include one or more rate controllers 221. Rate controller 221 may be circuits capable of adjusting a rate of scheduling of transmission queue entries by the queuing circuit 224 in response to a dI/dT event. A rate controller 221 may in some implementations be capable of determining a rate of ingress packets has exceeded an upper threshold or fallen below a lower threshold and in response instruct one or more queuing circuits 224 to respond to any dl/dT event by delaying the scheduling of transmission queue entries. This process may be as described in greater detail below in relation to the method 500 illustrated in FIG. 5.

In support of the functionality of the routing circuitry 206, processing circuitry 209 may be configured to control aspects of the routing circuitry 206 to accomplish throttling in relation to load-balancing. The processing circuitry 209 may in some implementations include a CPU, an ASIC, and/or other processing circuitry which may be capable of handling computations, decision-making, and management functions required for operation of the interconnect device 100.

Processing circuitry 209 may be configured to handle level management and control functions of the interconnect device 100, such as setting up routing tables, configuring ports, and otherwise managing operation of the interconnect device 100. Processing circuitry 209 may execute software and/or firmware to configure and manage the interconnect device 100, such as an operating system and management tools. In some implementations, the processing circuitry 209 may be configured to receive instructions from external devices such as processing devices 103 and/or client devices 109.

Memory 212 of an interconnect device 100 as described herein may comprise one or more memory elements capable of storing configuration settings, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

In some implementations, an interconnect device 100 as described herein may include one or more internal power supplies 215. An internal power supply 215 may be a capacitor, or other device capable of storing power received from an external power supply device 106 to be used by the interconnect device 100.

FIG. 3 illustrates elements of routing circuitry 206 of an interconnect device 100 in accordance with one or more implementations of the present disclosure. One or more ingress ports 203 may, upon receiving data, transmit the data to one or more ingress processing circuits 303. In some implementations, each ingress port 203 may be associated with a dedicated ingress processing circuit 303, while in other implementations, multiple ingress ports 203 may share an ingress processing circuit 303.

Each ingress processing circuit 303 may include one or more of a forward error correction (FEC) circuit 306, a decryption engine circuit 309, a control plane 312, and/or other circuits and components which may handle ingress packets and non-packetized ingress data. An FEC circuit 306 as described herein may be used to perform error detection and correction for packets received from a port 203 before the packets are directed to an egress port. The FEC circuit 306 may receive ingress data from a port 203 and, after performing FEC, output the received ingress data or a processed version of the ingress data to a decryption engine circuit 309.

A decryption engine circuit 309 as described herein may be used to decrypt all or a portion of received packets to enable the interconnect device 100 to determine a port 203 from which to send each packet. The decryption engine circuit 309 may be capable of ensuring that sensitive data remains protected from unauthorized access during traversal of the data through the interconnect device 100. The decryption engine circuit 309 may output received packets or data associated with received packets to one or more shared buffer circuits 318 via an ingress bandwidth measurement circuit 218 as described herein. The decryption engine circuit 309 may also output data associated with received packets to the control plane 312.

A control plane 312 as described herein may be used to manage how received data packets are forwarded and handled within the interconnect device 100. The control plane 312 may receive data associated with a received packet from the decryption engine circuit 309 and, based on the data associated with received packet, write instructions to one or more queueing circuits 224 as described herein.

Each of the FEC circuit 306, decryption engine circuit 309, control plane 312, and/or other circuits and components of the ingress processing circuits 303 may include one or more of an ASIC, FPGA, digital signal processor (DSP), network processor, accelerator, hardware secure module, CPU, and/or other components and circuits capable of performing ingress processing. As should be appreciated, each ingress processing circuit 303 of an interconnect device 100 may include one or more additional circuits and components in addition to or instead of the FEC circuit 306, decryption engine circuit 309, and control plane 312 described above.

Each of the ingress processing circuits 303 of the interconnect device 100 may be enabled to write data to a shared-buffer circuit 318 and a queueing circuit 224. Packets to be egressed from the interconnect device 100 may be stored in a shared-buffer circuit 318. Data which may be used by egress processing circuits 327 to route packets to egress ports 203 may be written to the queuing circuits 224. Once the queueing circuit 224 assigns a particular packet to a particular egress port 203, packet data stored in the shared buffer circuit 318 may be read by an egress processing circuit 327 associated with the particular egress port 203.

Data to be sent from the interconnect device 100 may be processed by one or more egress processing circuits 327. In some implementations, each port 203 which is used for egress may be associated with a dedicated egress processing circuit 327. In other implementations, multiple egress ports 203 may share one or more egress processing circuits 327.

An egress processing circuit 327 may include, but should not be considered as limited to, a packet modifier circuit 330 and an encryption engine 333. A packet modifier circuit 330 as described herein may include circuitry such as an ASIC, an FPGA, or other componentry capable of adjusting packets before the packets are transmitted from the interconnect device. Such adjustments may include, for example, the adding or removal of tags, modification of settings and packet header data, and other modifications. An encryption engine 333 as described herein may include circuitry such as an ASIC, an FPGA, or other componentry capable of encrypting packets before the packets are transmitted from the interconnect device. Such encryption may include, for example, use of encryption algorithms such as Advanced Encryption Standard (AES), RSA, or other algorithms.

After being processed by an egress processing circuit 327, a packet may be transmitted from the interconnect device 100 via an egress port 203. The egress port 203 may be directly connected to an ultimate destination of the packet or may be connected to another interconnect device 100 which may forward the packet towards the ultimate destination.

As described above, routing circuitry 206 of an interconnect device 100 may be capable of throttling the traversal of data through the interconnect device 100 in response to a surge or sudden drop in power consumption. Power consumption of an interconnect device 100 may be directly related to the amount of traffic traversing the interconnect device 100. As a result, the routing circuitry 206 may be configured to delay the scheduling of packets by the queuing circuit 224 in the event that the ingress bandwidth measurement circuit(s) 218 detects a surge or sudden drop in traffic. By delaying the scheduling of packets by the queuing circuit 224, components of the egress processing circuit 327 can be powered on or off at a slower rate as compared to the fastest possible rate. This slowing of the powering on or off of the egress processing circuit 327 can prevent an overshoot or undershoot as described above.

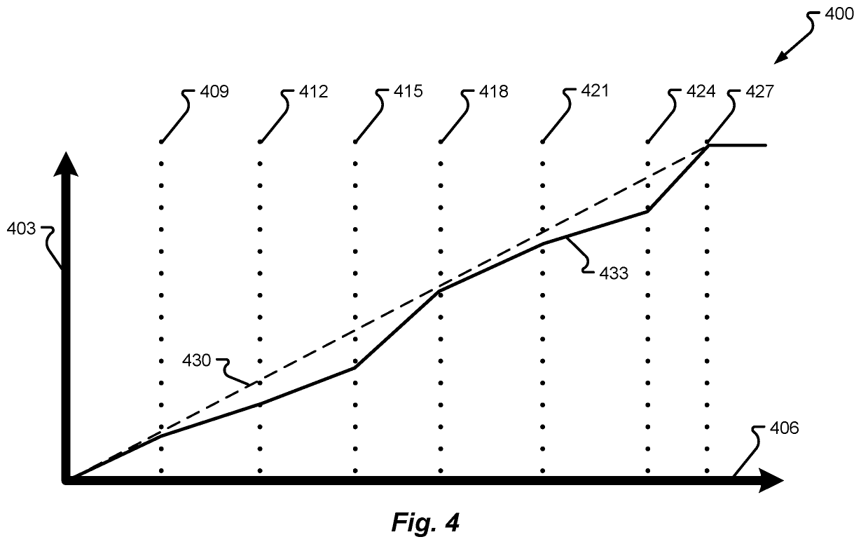

An example power consumption over time of an interconnect device 100 is illustrated in FIG. 4. The example interconnect device 100 from which the example power consumption is presented is illustrated as experiencing a sudden increase in traffic. At the origin of the plot, the interconnect device 100 is idle and not receiving traffic and is thus consuming a minimal amount of power. In this example, the interconnect device 100 is receiving a maximum amount of traffic across all ingress ports. In effect, the interconnect device 100 is going from idle to full wire speed (FWS) on all ports. The power consumption of the interconnect device 100 is plotted by the solid line 433, with power on the vertical axis 403 and time on the horizontal axis 406. The dashed line 430 illustrates the average change in power as the interconnect device 100 goes from idle to FWS on all ports.

When a conventional switch goes from idle to FWS on all ports, an undershoot scenario as described above occurs by the time the traffic is beginning to egress the switch. As described herein, an interconnect device 100 may be enabled to mitigate or avoid such a scenario. By delaying the scheduling of packets for egress when a sudden burst of traffic is received at ingress, the interconnect device 100 can reduce the slope of the dashed line 430 representing the average power increase to a rate which can be handled by the internal power supply 215 of the interconnect device 100. This may be achieved through a method 500 as described below in relation to FIG. 5.

Between the origin and the vertical marker 409, traffic has begun being received by ingress ports of the interconnect device 100. The increase in power consumption illustrated is used to power ingress ports 203 and related circuitry.

Between vertical markers 409 and 412, traffic is being processed by decryption circuitry of the interconnect device 100. The increase in power consumption illustrated is used to power the decryption circuitry. The decryption circuitry may, as illustrated in FIG. 3, comprise one or more decryption engine circuits 309 and/or other elements and may process received packets before the packets reach a shared buffer circuit 318.

Between vertical markers 412 and 415, traffic is being processed by control plane circuitry of the interconnect device 100. The increase in power consumption illustrated is used to power the control plane circuitry 312. The control plane circuitry 312 may, as illustrated in FIG. 3 may process received packet data and write to a queuing circuit 224.

Between vertical markers 415 and 418, traffic is being processed by buffer circuitry of the interconnect device 100. The increase in power consumption illustrated is used to power the buffer circuitry. The buffer circuitry may, as illustrated in FIG. 3, comprise one or more shared buffer circuits 318 and/or other elements and may store packets before the packets are scheduled for egress.

Between vertical markers 418 and 421, traffic is being processed by packet modification circuitry of the interconnect device 100. The increase in power consumption illustrated is used to power the packet modification circuitry. The packet modification circuitry may, as illustrated in FIG. 3, comprise a packet modifier circuit 330 and/or other elements and may perform packet modification as part of the egress packet processing.

Between vertical markers 421 and 424, traffic is being processed by encryption circuitry of the interconnect device 100. The increase in power consumption illustrated is used to power the encryption circuitry. The encryption circuitry may, as illustrated in FIG. 3, comprise an encryption engine 333 and/or other elements and may perform any encryption of packets prior to egress.

Between vertical markers 424 and 427, traffic is being processed by egress port circuitry of the interconnect device 100. The increase in power consumption illustrated is used to power the egress ports 203 and related circuitry.

After vertical marker 427, traffic is flowing through the interconnect device 100 at a maximum rate. The power consumption illustrated is at a maximum to power the interconnect device 100 at full speed.

The increase in power illustrated by the graph of FIG. 4 shows a scenario of an interconnect device 100 going from idle to FWS. It should be appreciated that the opposite scenario, of an interconnect device 100 going from FWS to idle, could be represented by the same graph when read from right to left. The dI/dT events described herein may be positive changes of power consumption, as illustrated in FIG. 4, or negative changes of power consumption. The methods described herein which resolve overshoot and undershoot issues relating to dl/dT events can be used to mitigate or avoid overshoot and undershoot issues whether resulting from increases or decreases in power consumption.

As described above, sudden increases or decreases in traffic can cause power supply issues in which the power supply experiences an overshoot or undershoot. Overshoots and undershoots are particularly an issue when an interconnect goes from idle to FWS or vice versa within a relatively short amount of time.

When a conventional switch goes from idle to FWS on all ports or vice versa, an undershoot or overshoot scenario as described above may occur. As described herein, an interconnect device 100 may be enabled to mitigate or avoid such a scenario. By delaying the scheduling of packets for egress when a sudden burst of traffic or sudden drop in traffic is received at ingress, the interconnect device 100 can slow the change in the increase or decrease of power to a rate which can be handled by the internal power supply 215 of the interconnect device 100. This may be achieved through a method 500 as described below in relation to FIG. 5.

As illustrated in FIG. 5, an example method 500 may be implemented by an interconnect device 100 as described herein to enable power consumption control in the event of a dl/dT event. As used herein, the term dl/dT event may refer to the absolute value of the rate of change in current over time for a period of time exceeding a threshold. The period of time may be a particular amount of time and may be dependent on the internal power supply 215 of the interconnect device 100. A positive dl/dT event may occur when an interconnect device 100 proceeds from consuming a relatively low amount of power to a relatively high amount of power in a relatively low amount of time. A negative dl/dT event may occur when an interconnect device 100 proceeds from consuming a relatively high amount of power to a relatively low amount of power in a relatively low amount of time. If the change in power consumption occurs over a sufficiently long amount of time, no overshoot or undershoot may occur. As such, the method 500 may be beneficial only for changes in power consumption occurring over a relatively low amount of time. The specific amount of time and the specific high and low power consumption levels may be device-specific and may be configurable via user settings.

As described above, an interconnect device 100 may be, for example, a switch or other type of computing system capable of receiving and forwarding data in a network. The interconnect device 100 may be utilized by one or more processing devices 103 and/or client devices 109 to provide interconnect services with one or more other processing devices 103 and/or client devices 109. The interconnect device 100 may receive power from one or more power supply devices 106. Such power supply devices 106 may be comprised by the interconnect device 100 or may be shared by a plurality of interconnect devices 100, processing devices 103, and/or client devices 109.

At 503, the interconnect device 100 may monitor ingress bandwidth. As illustrated in FIG. 3, ingress bandwidth may be measured using one or more ingress bandwidth measurement circuits 218 between ingress processing circuit(s) 303 and a shared buffer circuit 318. It should be appreciated that in some implementations ingress bandwidth may be measured at other points in the interconnect device 100. Ingress bandwidth may be measured on a per-port basis before being aggregated into a total ingress bandwidth or may be measured as a whole.

At 506, a determination may be made as to whether the ingress bandwidth has experienced a high rate of change. Determining the ingress bandwidth has experienced a high rate of change comprises, in some implementations, determining the ingress bandwidth has exceeded a particular increase or decrease within a particular amount of time. For example, determining the ingress bandwidth has experienced a high rate of change may comprise determining that the ingress bandwidth has increased from a lower threshold to an upper threshold within a particular amount of time or that the ingress bandwidth has decreased from an upper threshold to a lower threshold within a particular amount of time. The lower threshold may in some implementations be no traffic or may be a user-specified rate of traffic. The upper threshold may in some implementations be a maximum amount of traffic or may be a user-specified rate of traffic. The particular amount of time may be user-specified and/or may be based on capabilities of an internal power supply 215 of the interconnect device 100.

The interconnect device 100 may continue to monitor ingress bandwidth, at 503, until a high rate of change is detected at 506. In response to the high rate of change, the method 500 may comprise monitoring the queuing system of the interconnect device 100 for a period of time at 509. A positive dl/dT event as described herein may occur in the event that an interconnect device 100 experiences a sharp increase in ingress traffic followed by a sharp increase in egress traffic, resulting in power consumption of the interconnect device 100 escalating from a low amount to a high amount in such a small amount of time that an undershoot occurs. A negative dI/dT event as described herein may occur in the event that an interconnect device 100 experiences a sharp decrease in ingress traffic followed by a sharp decrease in egress traffic, resulting in power consumption of the interconnect device 100 falling from a high amount to a low amount in such a small amount of time that an overshoot occurs. If a sufficient amount of time passes between the escalation of the ingress traffic before the escalation of the egress traffic, then the positive dI/dT can be avoided. Similarly, if a sufficient amount of time passes between the decrease in the ingress traffic before the decrease the egress traffic, then the negative dl/dT can be avoided. For this reason, the queuing system may be monitored for only a particular amount of time necessary to avoid the positive or negative dl/dT event. The amount of time for monitoring the queuing system may vary based on factors such as a size of an internal power supply 215 or other variables and in some implementations may be user-configurable. As a non-limiting example, the amount of time may be 200 nanoseconds in some implementations.

Monitoring the queuing system may comprise determining contents of one or more queuing vectors stored in memory of a queueing circuit 224. Each entry in a queuing vector may represent a packet to be scheduled for egress. An empty queuing vector may represent a situation in which no packets are in the shared buffer circuit 318 waiting to be scheduled for egress. A full queuing vector may represent a situation in which a maximum number of packets are in the shared buffer circuit 318 waiting to be scheduled for egress. A rate controller 221 or other component of the interconnect device 100 may be configured to determine a rate of change of contents of one or more queuing vectors of the queuing circuit 224. The rate controller 221 may in some implementations compare the rate of change of contents of the one or more queuing vectors to one or more thresholds. For example, the rate controller 221 may be enabled to determine contents of the one or more queuing vectors has increased from below a lower threshold to above a higher threshold within a particular amount of time or has decreased from above a higher threshold to below a lower threshold within a particular amount of time. In some implementations, a queuing circuit 224 may comprise a plurality of vectors and each vector may be stored at a different place in memory. The rate controller 221 may in such an implementation be configured to aggregate contents of various vectors to determine a total content of the queuing circuit 224.

If, during the period of time that the queuing system is monitored, the rate controller 221 determines contents of the queuing vectors has increased from below a lower threshold to above a higher threshold within a particular amount of time or has decreased from above a higher threshold to below a lower threshold within a particular amount of time, the rate controller 221 may determine a dI/dT event has occurred at 512. If not, the method 500 may comprise returning to the monitoring of the ingress bandwidth at 503.

In response to detection of a dI/dT event at 512, the method 500 may comprise dynamically adjusting, referred to herein as controlling, the scheduling of packets by the queuing circuit 224 for egress at 515. Scheduling packets for egress may involve writing the packets to one or more egress queues. Before packets are scheduled for egress, the egress-related circuitry, such as packet modifier circuits 330, encryption engines 333, and egress ports 203, may be operating in a low-power mode and consuming a minimal amount of power. As the queuing circuit 224 begins to schedule packets for egress, the egress-related circuitry may begin to consume additional power. If the queuing circuit 224 schedules packets from the queuing vector as quickly as possible, the power consumption of the egress-related circuitry may increase at a steep rate and an undershoot may occur. In the event of a negative dl/dT event, in which a sharp decrease in the rate of traffic received by the interconnect device 100 occurs, if the queuing circuit schedules packets for egress at a maximum rate, the queuing circuit may empty so quickly that the reduction in power consumption of the interconnect device 100 may result in an overshoot.

By controlling the rate of the scheduling of packets for egress, the interconnect device 100 may delay the rise or fall of power consumption by the egress circuitry and avoid the occurrence of an overshoot or undershoot. Controlling the rate of the scheduling of packets for egress may comprise delaying the scheduling of packets. For example, the rate controller 221 may reduce the rate at which the queuing circuit 224 schedules packets. Reducing the rate may comprise scheduling the packets at a particular rate less than a maximum rate or may comprise gradually reducing the rate from a maximum rate to a lesser rate. Reducing the rate may in some implementations comprise pausing the scheduling of packets for a particular amount of time. In some implementations, reducing the rate may comprise initially reducing the rate to a lower rate or to zero before gradually raising the rate up to a maximum rate. A gradual decrease or increase in the rate may at intervals of one or more clock cycles. For example, at a first clock cycle two queue entries may be scheduled, at a second clock cycle four queue entries may be scheduled, at a third clock cycle six queue entries may be scheduled, and this process may continue until the queuing circuit 224 is scheduling all entries at once. It should be appreciated that implementations may include any combination of such reductions in the rate of scheduling of packets or any other particular methodologies for reducing a rate.

As should be appreciated, the controlling of the rate of the scheduling of packets for egress may occur for as long as necessary to avoid an excessively fast increase or decrease in power consumption. In some implementations, controlling the rate of the scheduling of packets for egress may be followed by a determination that the rate of change of either the scheduling of packets or the power consumption is below a threshold amount. In response to such a determination, the controlling of the rate of the scheduling of packets for egress may cease.

In some implementations, an explicit decision or determination that the rate of change of either the scheduling of packets or the power consumption is below a threshold amount may not be necessary. The controlling of the rate of the scheduling of packets for egress may occur for a predetermined amount of time or, as described above, may involve immediately dropping to a lower rate before gradually increasing to a maximum rate. The speed of the gradual increase may be tuned based on factors such as a size of the internal powers supply or other variables. In some implementations, the speed of the gradual increase may be conditional and may be, for example, adjusted automatically based on a rate of increase of the ingress traffic. For example, if a drastic increase in ingress traffic is experienced, the egress traffic may be controlled at a similarly drastic rate, while a lesser increase in ingress traffic may result in lesser controlling of the rate of the scheduling of packets for egress.

In some implementations, the controlling of the rate of scheduling of packets may affect only particular flows. For example, the controlling of the rate of scheduling of packets may affect a first one or more flows of a plurality of flows traversing the interconnect device 100 and a second one or more flows of the plurality of flows may continue unaffected by the controlling of the rate of scheduling. In this way, particular flows can traverse the interconnect device 100 as quickly as possible while the scheduling of other flows can be controlled to avoid potential overshoot or undershoot issues.

The present disclosure encompasses methods with fewer than all of the steps identified in FIG. 5 (and the corresponding description of the method 500), as well as methods that include additional steps beyond those identified in FIG. 5 (and the corresponding description of the method 500). The present disclosure also encompasses methods that comprise one or more steps from the methods described herein, and one or more steps from any other method described herein.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A switch comprising one or more circuits to:
determine a rate of change in a number of entries in a queue exceeds a first threshold; and
based on determining the rate of change in the number of entries in the queue exceeds the first threshold, dynamically adjust a rate at which packets to be transmitted from the switch are processed for egress.

2. The switch of claim 1, wherein the one or more circuits are further to:
after dynamically adjusting the rate at which the packets to be transmitted from the switch are processed for egress, determine the rate of change is below the first threshold; and
in response to determining the rate of change is below the first threshold, cease dynamically adjusting the rate at which the packets to be transmitted from the switch are processed for egress.

3. The switch of claim 1, wherein dynamically adjusting the rate at which the packets to be transmitted from the switch are processed for egress comprises increasing the rate from a first rate to a second rate over time.

4. The switch of claim 3, wherein the second rate is a maximum rate.

5. The switch of claim 1, wherein dynamically adjusting the rate at which the packets to be transmitted from the switch are processed for egress controls an increase in an amount of power consumed by the switch.

6. The switch of claim 5, wherein the increase in the amount of power consumed by the switch is delayed.

7. The switch of claim 1, wherein dynamically adjusting the rate at which the packets to be transmitted from the switch are processed for egress comprises delaying a scheduling of the packets to be transmitted from the switch to one or more egress queues.

8. The switch of claim 1, wherein dynamically adjusting the rate at which the packets to be transmitted from the switch are processed for egress affects a first one or more flows of a plurality of flows traversing the switch and a second one or more flows of the plurality of flows continue unaffected by the adjusting of the rate at which the packets to be transmitted from the switch are processed for egress.

9. The switch of claim 1, wherein:
the one or more circuits are further to determine a rate of change in a number of packets ingressing the switch, and
dynamically adjusting the rate at which the packets to be transmitted from the switch are processed for egress is further in response to determining the rate of change in a number of packets ingressing the switch exceeds a second threshold.

10. The switch of claim 1, wherein each entry represents a respective packet of a plurality of packets to be transmitted from the switch.

11. A method, comprising:
determining a rate of change in a number of entries in a queue exceeds a first threshold; and
based on determining the rate of change in the number of entries in the queue exceeds the first threshold, dynamically adjusting a rate at which packets to be transmitted from a switch are processed for egress.

12. The method of claim 11, further comprising:
after dynamically adjusting the rate at which the packets to be transmitted from the switch are processed for egress, determining the rate of change is below the first threshold; and
in response to determining the rate of change is below the first threshold, ceasing dynamically adjusting the rate at which the packets to be transmitted from the switch are processed for egress.

13. The method of claim 11, wherein dynamically adjusting the rate at which the packets to be transmitted from the switch are processed for egress comprises increasing the rate from a first rate to a second rate over time.

14. The method of claim 11, wherein dynamically adjusting the rate at which the packets to be transmitted from the switch are processed for egress controls an increase in an amount of power consumed by the switch.

15. The method of claim 11, wherein dynamically adjusting the rate at which the packets to be transmitted from the switch are processed for egress comprises delaying a scheduling of the packets to be transmitted from the switch to one or more egress queues.

16. A switch comprising one or more circuits to:
determine a negative rate of change in a number of packets ingressing the switch exceeds a threshold; and
in response to determining the negative rate of change in the number of packets ingressing the switch exceeds the threshold, dynamically adjust a rate at which the packets to be transmitted from the switch are processed for egress.

17. The switch of claim 16, wherein dynamically adjusting the rate at which the packets to be transmitted from the switch are processed for egress controls a reduction in an amount of power consumed by the switch.

18. The switch of claim 16, wherein dynamically adjusting the rate at which the packets to be transmitted from the switch are processed for egress comprises delaying a scheduling of the packets to be transmitted from the switch to one or more egress queues.

19. The switch of claim 16, wherein the one or more circuits are further to:
after dynamically adjusting the rate at which the packets to be transmitted from the switch are processed for egress, determine the negative rate of change is below the threshold; and
in response to determining the rate of change is below the threshold, cease dynamically adjusting the rate at which the packets to be transmitted from the switch are processed for egress.

20. The switch of claim 16, wherein dynamically adjusting the rate at which the packets to be transmitted from the switch are processed for egress comprises decreasing the rate from a first rate to a second rate over time.
